(19) United States
(12) Patent Application Publication
(10) Pub. No.: US 2026/0170987 A1
(43) Pub. Date: Jun. 18, 2026

(54) DISPLAY APPARATUS AND DRIVING METHOD THEREOF

(71) Applicant: LG Display Co., Ltd., Seoul (KR)

(72) Inventors: Kiduk Kim, Paju-si (KR); Jaekyeong Yun, Goyang-si (KR)

(73) Assignee: LG Display Co., Ltd., Seoul (KR)

(21) Appl. No.: 19/337,307

(22) Filed: Sep. 23, 2025

(30) Foreign Application Priority Data
Dec. 17, 2024 (KR) 10-2024-0187915

(51) Int. Cl. G09G 3/20; G09G 3/3233; G09G 3/3275

(52) U.S. Cl. CPC G09G 3/2007; G09G 3/3275; G09G 3/3233; G09G 2300/0842; G09G 2310/0297; G09G 2310/08; G09G 2320/0233; G09G 2320/0242; G09G 2320/10

(57) ABSTRACT

This specification discloses a display apparatus and a driving method thereof. The display apparatus determines the output order of image data to prioritize low-grayscale image data and sets the switching order of the demultiplexer accordingly, thereby preventing or suppressing luminance degradation caused by insufficient charging time and enabling sub-pixels to be charged to a desired grayscale, thus improving the image quality of the display apparatus employing demultiplexer technology.

### CROSS REFERENCE TO RELATED APPLICATION

The present application claims priority to Korean Patent Application No. 10-2024-0187915, filed Dec. 17, 2024, the entire contents of which is incorporated herein for all purposes by this reference.

### BACKGROUND

The present specification relates to a display apparatus, and more particularly, to a display apparatus and a driving method thereof for improving data charging characteristics associated with time-division driving.

An organic light-emitting display apparatus is a self-emissive display device that, unlike a liquid crystal display, requires no separate light source, enabling lightweight and thin manufacturing. Additionally, an organic light-emitting display apparatus offers advantages in power consumption due to low-voltage driving and excels in color reproduction, response speed, viewing angle, and contrast ratio (CR), positioning it as a next-generation display under research.

Display apparatuses are continuously improved to enhance screen resolution and luminance, providing users with clearer images.

### SUMMARY

The display apparatus applies demultiplexer technology to reduce the number of data pins supplied from the data driver to the data lines of the display panel. In the demultiplexer technology, the switches of the demultiplexer are driven in a time-division manner so that the data voltage of a single data pin is sequentially delivered to a plurality of subpixels.

However, in the conventional technology, when a high grayscale voltage is applied to the first switch that is turned on during the time-division driving of the demultiplexer, there is insufficient charging time, resulting in a failure to express the desired grayscale. To address this, the inventors of this specification have devised a display apparatus capable of preventing or suppressing image quality degradation caused by insufficient charging time during the time-division driving of the demultiplexer.

An object of embodiments of the present specification is to provide a display apparatus and a driving method thereof capable of resolving the issue of luminance reduction caused by insufficient charging time depending on the load of the display panel during demultiplexer driving.

Another object of the present specification is to provide a display apparatus and a driving method thereof capable of reducing color shift and line mura caused by differences in the charging rates of individual subpixels during demultiplexer driving.

The objectives of this specification are not limited to those mentioned above, and other objectives not mentioned can be clearly understood by those skilled in the art from the detailed description.

A display apparatus according to an example embodiment of this specification is provided. The display apparatus determines the output order of image data to prioritize low-grayscale image data and determines the switching sequence of the demultiplexer based on this output order.

According to an example embodiment, the display apparatus compares the magnitude of image data within a horizontal period and determines the output order of image data in an ascending order, starting from the lowest grayscale data among the image data within the horizontal period.

A display apparatus according to an example embodiment of this specification is provided. The display apparatus includes a demultiplexer that selectively delivers a data voltage from a single data pin to first to fifth subpixels via first to fifth switches, respectively, and a controller that compares the magnitudes of first to fifth image data in a first horizontal period, determines the output order of the first to fifth image data to be output in an ascending order starting from the lowest grayscale data, among the first to fifth image data, and controls the first to fifth switches based on the output order of the first to fifth image data.

A method for driving a display apparatus according to an example embodiment of this specification is provided. The method for driving a display apparatus includes comparing the magnitudes of first to fifth image data in a first horizontal period, arranging the first to fifth image data to be output in an ascending order starting from the lowest grayscale image data, among the first to fifth image data, and arranging switch control signals to drive the first to fifth switches of the demultiplexer in accordance with the output order of the first to fifth image data.

A display apparatus according to example embodiments of this specification is advantageous in preventing or suppressing luminance reduction caused by insufficient charging time and in improving image quality by determining the switching order of the demultiplexer based on the grayscale of the image data and outputting the image data in an ascending order starting from the lowest grayscale data.

In addition, the display apparatus according to example embodiments of this specification is advantageous in improving image quality by controlling the switches of the demultiplexer to charge subpixels in an ascending order from low-grayscale data, thereby ensuring that the subpixels are charged to the desired grayscale.

In addition, the display apparatus according to example embodiments of this specification is advantageous in charging the subpixels to the desired grayscale even when there is a significant grayscale difference between adjacent subpixels by controlling the switches of the demultiplexer to charge the subpixels in an ascending order starting from the lowest grayscale image data.

In addition, the display apparatus according to example embodiments of this specification is advantageous in reducing color shift and line mura caused by differences in charging rates between subpixels by determining the switching order of the demultiplexer based on the grayscale of the image data and turning on the switches of the demultiplexer according to the determined switching order.

In addition, the display apparatus according to example embodiments of this specification is advantageous in sufficiently charging the subpixels to the desired grayscale even when charging time is insufficient, by adjusting the switching order of the demultiplexer based on the grayscale of the image data and turning on the switches of the demultiplexer to first deliver the data voltage corresponding to the lower grayscale data.

In addition, the display apparatus according to example embodiments of this specification is advantageous in resolving the problem of luminance reduction in the first subpixel when a high grayscale is applied to the first subpixel in a random pattern, by controlling the switches of the demultiplexer to charge the subpixels in an ascending order starting from the lowest grayscale subpixel.

In addition, the display apparatus according to example embodiments of this specification is advantageous in reducing color shift and line mura by controlling the switches of the demultiplexer to charge the subpixels in an ascending order starting from the lowest grayscale subpixel, even in a one-by-one pattern where high and low grayscale values alternate.

In addition, the display apparatus according to example embodiments of this specification is advantageous in improving image quality by resolving luminance reduction caused by insufficient charging time due to the load of the display panel, by controlling the switches of the demultiplexer to charge the subpixels in an ascending order starting from the lowest grayscale subpixel.

In addition to the aforementioned effects and advantages, other advantageous effects of the present disclosure will be provided along with the detailed description of the disclosure or may be understood by those skilled in art from the detailed description.

### BRIEF DESCRIPTION OF THE DRAWINGS

The accompanying drawings, which are included to provide a further understanding of the present disclosure and are incorporated in and constitute a part of this application, illustrate example embodiments of the present disclosure and together with the description serve to explain the principles of the disclosure. In the drawings:

FIG. 1 is a block diagram illustrating a display apparatus according to an example embodiment of this specification;

FIG. 2 is a circuit diagram of a pixel included in a display apparatus according to an example embodiment of this specification;

FIG. 3 a schematic diagram illustrating a demultiplexer of a display apparatus according to an example embodiment of this specification;

FIG. 4 illustrates an operation timing diagram of FIG. 3;

FIG. 5 illustrates an operation timing diagram of FIG. 3 according to an example image pattern;

FIG. 6 is a diagram illustrating the control flow of a display apparatus according to an example embodiment of this specification;

FIG. 7 is a flowchart illustrating the control flow of a display apparatus according to an example embodiment of this specification;

FIG. 8 is a diagram illustrating the control flow of a display apparatus according to another example embodiment of this specification;

FIG. 9 is a flowchart illustrating the control flow of a display apparatus according to another example embodiment of this specification;

FIG. 10 illustrates an operation timing diagram of a display apparatus according to an example embodiment of this specification; and

FIG. 11 illustrates another operation timing diagram of a display apparatus according to an example embodiment of this specification.

### DETAILED DESCRIPTION

Advantages and features disclosed in this specification and methods of accomplishing the same may be understood more readily by reference to the detailed description of example embodiments that will be made hereinafter with reference to the accompanying drawings. However, this present disclosure is not limited to the example embodiments disclosed below and may be implemented in various different forms. These embodiments are provided merely to ensure that the description of the present disclosure is complete and to fully inform those of ordinary skill in the art of the scope of the disclosure. The protected scope of the present disclosure may be defined by the scope of the claims and their equivalents.

The shapes, sizes, ratios, angles, numbers and the like illustrated in the drawings to describe embodiments of the specification are merely examples, and thus, the specification is not limited thereto. Throughout the specification, the same reference numerals refer to the same components. In addition, detailed descriptions of well-known technologies may be omitted in the specification to avoid obscuring the subject matter of the specification.

Where such terms as “comprises,” “has,” “includes,” or “is made up of” are used in this specification, it should be understood that, unless a more limiting term like “only” is specifically used, additional elements or steps can be included. Unless otherwise explicitly stated, where a component is expressed in the singular form, it is intended to encompass the plural form as well.

In interpreting the components, they are to be construed to include a margin of error even in the absence of explicit description.

In the case of describing positional relationships, for example, where the positional relationship between two components is described using such terms as “on,’ “on top of,” “below,” or “beside,” one or more other components may be positioned between the two components unless a more limiting term like “directly” or “immediately” is specified.

Where temporal relationships are described, such expressions as “after,” “following,” “next,” or “before” may indicate a sequence of events, and unless a more limiting term like “immediately” or “directly” is used, non-continuous cases may also be included.

Where a signal flow relationship is described, for example, in the case of “a signal is transmitted from node A to node B,” instances where the signal is transmitted from node A to node B via another node may also be included unless a more limiting term like “immediately” or “directly” is specified.

Terms like “first,” “second,” etc., are used to describe various components, but these components are not limited by these terms. These terms are merely used for referring to one component separately from the other components. Therefore, the first component mentioned hereinafter may be the second component, and vice versa, in the technical sense of this specification.

The various features of the embodiments of the disclosure can combined or assembled together, either partially or entirely, in a technically diverse manner, and each embodiment can be independently implemented or in conjunction with related embodiments.

Hereinafter, a display apparatus and a driving method thereof according to example embodiments of this specification will be described, which are capable of reducing luminance degradation due to insufficient charging time caused by the load of the display panel during demultiplexer switching, and of reducing color shift and line mura caused by differences in charging rates among subpixels.

Various example embodiments of this specification will now be described in detail with reference to the accompanying drawings.

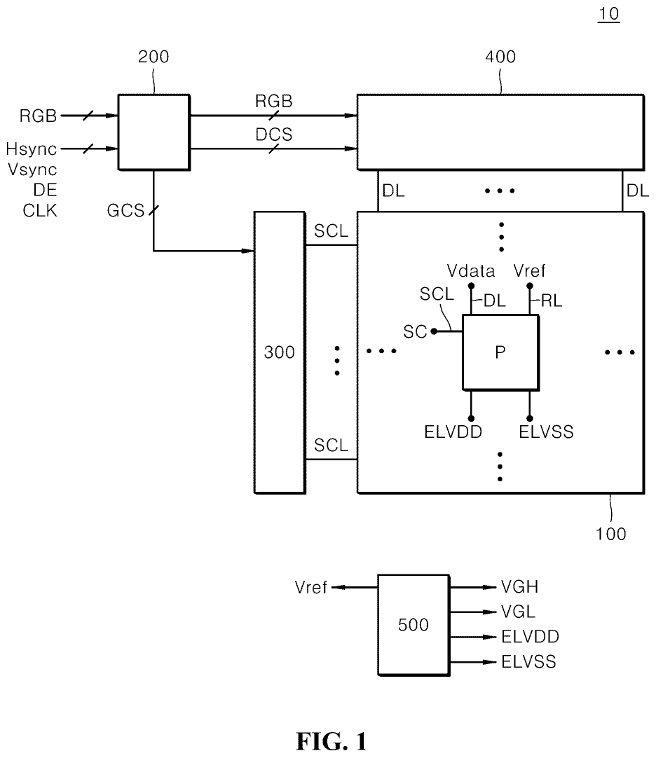

FIG. 1 is a block diagram illustrating a display apparatus according to an example embodiment of this specification.

As illustrated in FIG. 1, a display apparatus 10 includes a display panel 100 including a plurality of pixels P, a controller 200, a gate driver 300 supplying scan signals SC to the plurality of pixels P, a data driver 400 supplying data voltages Vdata to the plurality of pixels P, and a power supply 500 providing voltages for driving the plurality of pixels P.

In the display panel 100, a plurality of scan lines SCL and a plurality of data lines DL intersect each other, and each of a plurality of pixels P is connected to a scan line SCL and a data line DL. Specifically, one pixel P receives a scan signal SC via a scan line SCL and receives a data voltage Vdata via a data line DL, and receives a reference voltage Vref, a high-potential driving voltage ELVDD, and a low-potential driving voltage ELVSS from the power supply 500.

The scan line SCL supplies the scan signal SC and a sensing signal to the pixel P, and the data line DL supplies the data voltage Vdata to the pixel P. In addition, according to various embodiments, the scan line SCL and the sensing line that supplies the sensing signal may be individually connected to the pixel P.

Further, the plurality of pixels P may receive the high-potential driving voltage ELVDD and the low-potential driving voltage ELVSS via power lines, and may receive the reference voltage Vref via a reference voltage line RL.

Each pixel P includes a light-emitting element and a pixel circuit controlling the driving of the light-emitting element. The pixel circuit includes a plurality of switching elements, a driving element, and a capacitor. Here, the switching elements and driving element may be composed of thin-film transistors. In the pixel circuit, the driving element controls the current supplied to the light-emitting element based on the data voltage, thereby adjusting the light emission amount of the light-emitting element. Additionally, the plurality of switching elements operate the pixel circuit by receiving a scan signal SC supplied through the plurality of scan lines SCL and a reference voltage Vref supplied through the reference voltage line RL.

The display panel 100 may be implemented as a non-transmissive display panel or a transmissive display panel. A transmissive display panel may be applied to a transparent display apparatus in which an image is displayed on the screen while allowing background objects to remain visible. The display panel 100 may be fabricated as a flexible display panel. A flexible display panel may be implemented as an OLED panel using a plastic substrate.

Each pixel P may be divided into a red subpixel, a green subpixel, and a blue subpixel for color implementation. Each pixel P may further include a white subpixel.

Touch sensors may be disposed on the display panel 100. Touch input may be sensed using separate touch sensors or through the pixels P. The touch sensors may be implemented as on-cell type or add-on type touch sensors disposed on the screen of the display panel, or as in-cell type touch sensors embedded in the display panel 100.

The controller 200 processes image data RGB input from a host system to match the size and resolution of the display panel 100, and supplies the processed data to the data driver 400. The controller 200 generates a gate control signal GCS and a data control signal DCS using synchronization signals input from an external source, such as a clock signal CLK, a data enable signal DE, a horizontal synchronization signal Hsync, and a vertical synchronization signal Vsync. The controller 200 supplies the generated gate control signal GCS and data control signal DCS to the gate driver 300 and the data driver 400, respectively, thereby controlling the gate driver 300 and the data driver 400.

The voltage level of the gate control signal GCS output from the controller 200 may be converted into gate on voltage and gate off voltage through a level shifter and supplied to the gate driver 300. The level shifter converts the low-level voltage of the gate control signal GCS into gate low voltage VGL and converts the high-level voltage of the gate control signal GCS into gate high voltage VGH. The gate control signal GCS includes a start pulse and a shift clock.

The gate driver 300 supplies the scan signal SC to the scan wiring SCL according to the gate control signal GCS. The gate driver 300 may be arranged on one or both sides of the display panel 100 in a Gate In Panel (GIP) configuration.

The gate driver 300 sequentially outputs the scan signal SC to the plurality of scan wires SCL. The gate driver 300 can sequentially supply the scan signal SC to the scan wiring SCL by shifting the scan signal SC using a shift register. The scan signal SC may include a scan pulse swinging between the gate low voltage VGL and the gate high voltage VGH. In various embodiments, the gate driver 300 may sequentially output sensing signals to a plurality of sensing wires. The sensing signal may include a scan pulse swinging between the gate low voltage VGL and the gate high voltage VGH.

The gate driver 300 outputs the scan pulse in response to the start pulse and shift clock from the controller 200, and sequentially shifts the scan pulse according to the shift clock.

The data driver 400 converts the image data RGB into data voltage Vdata according to the data control signal DCS and supplies the converted data voltage Vdata to the pixel P through the data wiring DL.

In FIG. 1, the data driver 400 is illustrated as being disposed on one side of the display panel 100 in a single form, but the number and arrangement position of the data driver 400 are not limited thereto. That is, the data driver 400 may be composed of a plurality of integrated circuits (ICs) and may be arranged separately on one side of the display panel 100.

The power supply 500 generates the direct current (DC) power necessary for driving the pixel array of the display panel 100, the gate driver 300, and the data driver 400. The power supply 500 may include a charge pump, regulator, buck converter, boost converter, etc.

The power supply 500 receives the input voltage from the host system and generates DC voltages such as gate high voltage VGH, gate low voltage VGL, high-potential driving voltage ELVDD, low-potential driving voltage ELVSS, and reference voltage Vref. The gate low voltage VGL and gate high voltage VGH may be supplied to the gate driver 300. The high-potential driving voltage ELVDD, low-potential driving voltage ELVSS, and reference voltage Vref may be supplied to the pixels P.

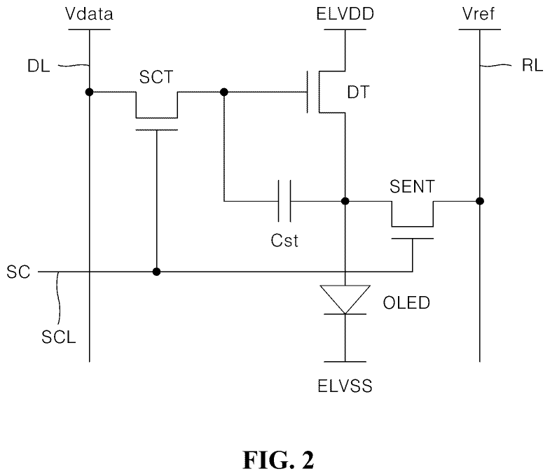

FIG. 2 is a circuit diagram of a pixel included in a display apparatus according to an example embodiment of this specification.

As illustrated in FIG. 2, each pixel is defined by a scan wiring SCL, data wiring DL, power wiring, and reference voltage wiring RL. Each pixel includes a scan transistor SCT, a driving transistor DT, a light-emitting element OLED, a sensing transistor SENT, and a storage capacitor Cst.

The scan transistor SCT selects the pixel to be driven by applying the data voltage Vdata to the driving transistor DT. The scan transistor SCT is positioned at the intersection of the scan wiring SCL and the data wiring DL. The scan transistor SCT includes a gate electrode, a source electrode, and a drain electrode. The gate electrode is connected to the scan wiring SCL. The source electrode is connected to the data wiring DL, and the drain electrode is connected to the driving transistor DT.

The driving transistor DT drives the light-emitting element OLED of the selected pixel, as chosen by the scan transistor SCT. The driving transistor DT includes a gate electrode, a source electrode, and a drain electrode. The gate electrode is connected to the drain electrode of the scan transistor SCT, the source electrode is connected to the power wiring, which applies the high-potential driving voltage ELVDD, and the drain electrode is connected to the anode electrode of the light-emitting element OLED.

The storage capacitor Cst functions to sample the data voltage Vdata. The storage capacitor Cst includes a first electrode and a second electrode. The first electrode of the storage capacitor Cst is connected to the node between the drain electrode of the scan transistor SCT and the gate electrode of the driving transistor DT, and the second electrode of the storage capacitor Cst is connected to the node between the drain electrode of the driving transistor DT and the anode electrode of the light-emitting element OLED.

The light-emitting element OLED is a self-emissive device, and its emission intensity is adjusted according to the amount of current flowing therethrough. For example, the light-emitting element OLED may be an organic light-emitting diode. The light-emitting element OLED includes an anode electrode, a light-emitting layer, and a cathode electrode. The anode electrode of the light-emitting element OLED is connected to the drain electrode of the driving transistor DT and the second electrode of the storage capacitor Cst, while the cathode electrode is connected to the power wiring, which applies the low-potential driving voltage ELVSS, and the light-emitting layer is placed between the anode electrode and the cathode electrode.

The sensing transistor SENT is used to initialize the anode electrode of the light-emitting element OLED and the second electrode of the storage capacitor Cst to the reference voltage Vref or to sense the pixel characteristics. The sensing transistor SENT includes a gate electrode, a source electrode, and a drain electrode. The gate electrode of the sensing transistor SENT is connected to the scan wiring SCL, the drain electrode of the sensing transistor SENT is connected to the anode electrode of the light-emitting element OLED, the drain electrode of the driving transistor DT, and the second electrode of the storage capacitor Cst. The source electrode of the sensing transistor SENT is connected to the reference voltage wiring RL. According to various embodiments, the gate electrode of the sensing transistor SENT may be connected to a sensing wiring that supplies a separate sensing signal.

The driving transistor DT adjusts the current flowing through the light-emitting element OLED according to the magnitude of the data voltage Vdata.

Furthermore, according to some embodiments, at least one of the transistors in the pixel circuit may be formed as a P-type thin-film transistor or an N-type thin-film transistor. Each transistor and the driving transistor may be formed from various types of transistors such as LTPS, oxide, single-silicon, organic, etc. The light-emitting element OLED may apply self-emitting diodes such as organic light-emitting elements or micro-LEDs. The substrate on which the pixel is formed may be made of glass, plastic, flexible plastic, wafer, etc.

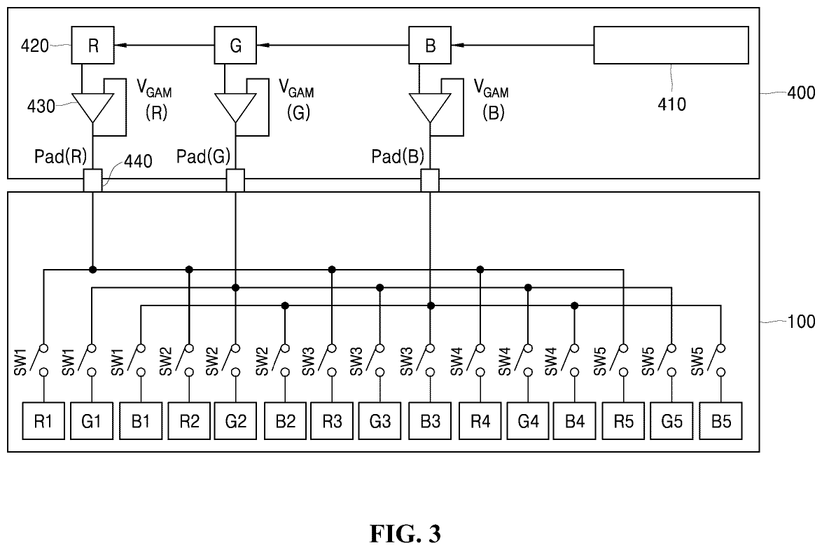

FIG. 3 a schematic diagram illustrating a demultiplexer of a display apparatus according to an example embodiment of this specification.

As illustrated in FIG. 3, the display apparatus includes a data driver 400 and a display panel 100.

The data driver 400 includes a grayscale voltage generator 410, a digital-to-analog converter 420, and an output buffer 430.

The grayscale voltage generator 410 provides a plurality of grayscale voltages to the digital-to-analog converter 420. For example, the grayscale voltage generator 410 may generate 10-bit grayscale voltages and provide them to the digital-to-analog converter 420.

The digital-to-analog converter 420 receives image data and grayscale voltages and outputs grayscale voltages (VGAM(R), VGAM(G), VGAM(B)) corresponding to the image data as data voltages. The digital-to-analog converter 420 may be divided into a red digital-to-analog converter for outputting red grayscale voltages VGAM(R), a green digital-to-analog converter for outputting green grayscale voltages VGAM(G), and a blue digital-to-analog converter for outputting blue grayscale voltages VGAM(B). For example, the digital-to-analog converter 420 may have a resolution of 10 bits and output red, green, and blue grayscale voltages in 1024 steps based on the image data.

The output buffer 430 outputs the data voltage received from the digital-to-analog converter 420 to the display panel 100. For example, the output buffer 430 may be a unity gain amplifier. The output terminal of the output buffer 430 is connected to the display panel 100 via a data pin 440. The data pin 440 may be classified into a red data pin Pad(R), a green data pin Pad(G), and a blue data pin Pad(B). In this specification, the red data pin Pad(R) may be defined as a pin at which the red grayscale voltage VGAM(R) is output as the data voltage. The green data pin Pad(G) may be defined as a pin at which the green grayscale voltage VGAM(G) is output as the data voltage. The blue data pin Pad(B) may be defined as a pin at which the blue grayscale voltage VGAM(B) is output as the data voltage.

The display panel 100 includes a demultiplexer having a plurality of switches SW1, SW2, SW3, SW4, and SW5 and a plurality of subpixels R1 to R5, G1 to G5, and B1 to B5. In this specification, although the display panel 100 is illustrated as including red, green, and blue subpixels, it is not limited thereto. The display panel 100 may further include white subpixels.

The plurality of switches SW1, SW2, SW3, SW4, and SW5 of the demultiplexer selectively connect the data pins 440 of the data driver 400 with the plurality of subpixels R1 to R5, G1 to G5, B1 to B5.

The plurality of switches SW1, SW2, SW3, SW4, and SW5 of the demultiplexer may be driven in a time-division manner according to switch control signals provided from a controller 200. That is, the plurality of switches SW1, SW2, SW3, SW4, SW5 of the demultiplexer may selectively turn on or off in response to the switch control signals.

For example, the switches SW1, SW2, SW3, SW4, and SW5 of the demultiplexer connected to the red data pin Pad(R) may be driven in a time-division manner according to the switch control signals to deliver the red grayscale voltage VGAM(R) as the data voltage to the first to fifth red subpixels R1 to R5. The switches SW1, SW2, SW3, SW4, and SW5 of the demultiplexer connected to the green data pin Pad(G) may be driven in a time-division manner according to the switch control signals to deliver the green grayscale voltage VGAM(G) as the data voltage to the first to fifth green subpixels G1 to G5. The switches SW1, SW2, SW3, SW4, SW5 of the demultiplexer connected to the blue data pin Pad(B) may be driven in a time-division manner according to the switch control signals to deliver the blue grayscale voltage VGAM(B) as the data voltage to the first to fifth blue subpixels B1 to B5.

The first subpixels R1, G1, and B1 may simultaneously receive red, green, and blue data voltages by the first switches SW1. The second subpixels R2, G2, and B2 may simultaneously receive red, green, and blue data voltages by the second switches SW2. The third subpixels R3, G3, and B3 may simultaneously receive red, green, and blue data voltages by the third switches SW3. The fourth subpixels R4, G4, and B4 may simultaneously receive red, green, and blue data voltages by the fourth switches SW4. The fifth subpixels R5, G5, and B5 may simultaneously receive red, green, and blue data voltages by the fifth switches SW5. As such, the subpixels of the first horizontal line of the display panel may receive data voltages in a time-division driving method.

The demultiplexer technology exemplified in this specification is intended to illustrate a method for reducing the number of data pins 440 supplied via five data lines to one-fifth, but is not limited thereto. The number of switches of the multiplexer may be implemented as two or more.

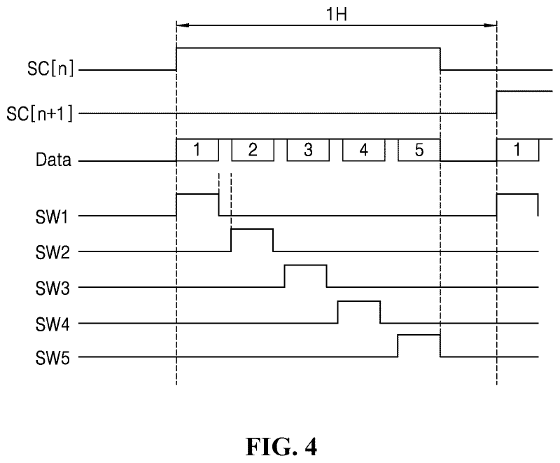

FIG. 4 illustrates an operation timing diagram of FIG. 3.

As illustrated in FIG. 4, the display apparatus may sequentially turn on the switches SW1, SW2, SW3, SW4, and SW5 of the demultiplexer during one horizontal period 1H, allowing the data voltages to be delivered to the first to fifth subpixels. In this case, the first scan signal SC[n] may be enabled during the period in which the data voltages for the first horizontal line are output, and the second scan signal SC[n+1] may be enabled during the period in which the data voltage for the second horizontal line are output.

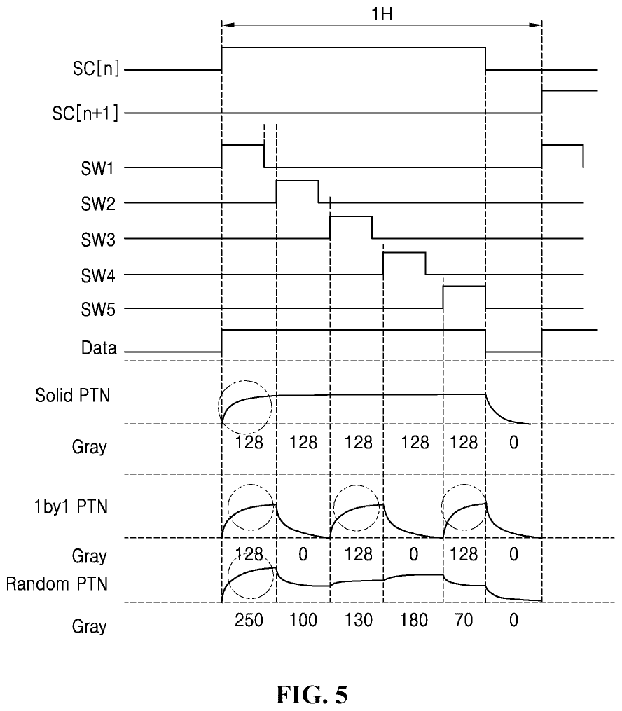

FIG. 5 illustrates an operation timing diagram of FIG. 3 according to an image pattern.

In the demultiplexing technique, when the display apparatus shares the output buffer 430 of the data driver 400, luminance imbalance may occur for specific image patterns, primarily due to the influence of previously applied image data and the switching order of the demultiplexer.

When the charging time is insufficient due to the panel load during demultiplexer switching, the subpixel connected to the first switch SW1 of the demultiplexer may experience insufficient charging, resulting in image quality degradation. Alternatively, when there is a large grayscale difference between adjacent subpixels, the adjacent subpixel may also experience insufficient charging, leading to image quality degradation.

As illustrated in FIG. 5, in the case of a solid pattern (Solid PTN), for example, when image data corresponding to the first grayscale value of “128” is applied, the first subpixel's luminance may be lower than that of the second to fifth subpixels due to insufficient charging time caused by the first switch SW1 turning off before the first grayscale value of “128” is fully charged. When the luminance of the first subpixel is lower than that of other subpixels, line mura may occur.

Additionally, in the case of a one-by-one pattern (1by1 PTN), for example, when the image data alternates between the first grayscale “128” and the second grayscale “0,” subpixels that are to express the first grayscale may not sufficiently express the desired grayscale due to insufficient charging time. For example, when the display panel is driven at a high frequency, the duration of the horizontal period becomes shorter, further reducing the available charging time and exacerbating the charging issue. In FIG. 5, the circles indicate portions where charging issues occur.

Furthermore, in the case of a random pattern (Random PTN), for example, when image data with grayscale values such as 250, 100, 130, 180, and 70 is applied, the first subpixel may fail to express the desired grayscale value of 250 due to insufficient charging time before the first switch SW1 is turned off.

To address these issues, this specification provides a display apparatus capable of reducing color shifts and line mura caused by differences in charging rates, even in one-by-one patterns where high and low grayscale values are alternately applied.

In addition, this specification provides a display apparatus capable of solving the problem of luminance degradation of the first subpixel when a high grayscale is applied to the first subpixel in a random pattern.

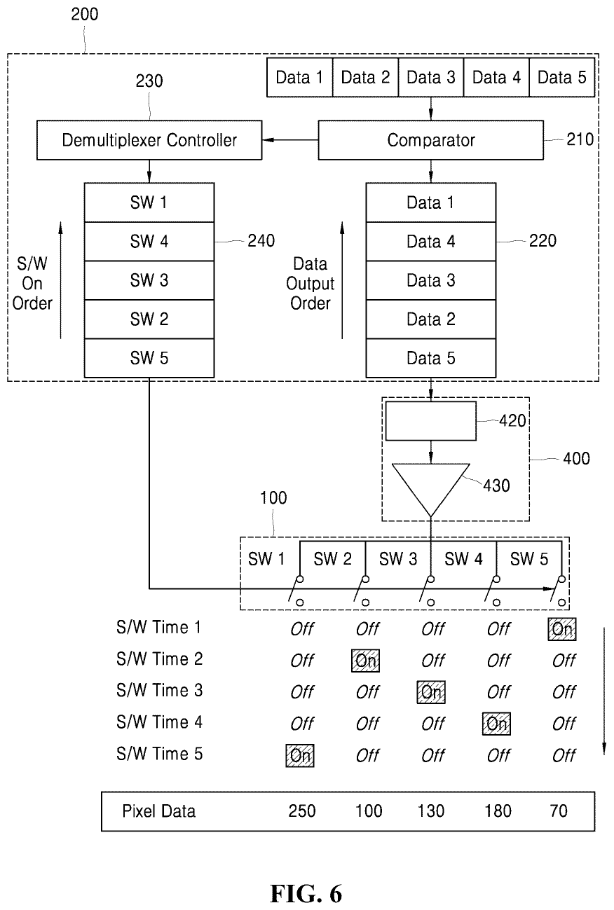

FIG. 6 is a diagram illustrating the control flow of a display apparatus according to an example embodiment of this specification.

As illustrated in FIG. 6, the display apparatus includes a controller 200 that determines the output order of image data such that lower-grayscale image data is output first to the data driver 400, and, based on that output order, determines the switching sequence of the demultiplexer. In the embodiment of FIG. 6, the controller 200 determines both the output order of the image data and the corresponding demultiplexer switching sequence based on the values of the image data, but this arrangement is not limiting. Alternatively, the output order of image data may be determined based on the values of the image data and the switching order of the demultiplexer may be determined according to the output order of the image data. Alternatively, a separate control device (not shown) may determine the output order of image data based on the values of the image data and may determine the switching order of the demultiplexer according to the output order of the image data.

The controller 200 receives first to fifth image data Data1, Data2, Data3, Data4, and Data5 from a host system, compares the magnitudes of Data1-Data5 during a horizontal period 1H, and determines their output order in ascending order from the lowest grayscale value.

For example, when there are five switches in the demultiplexer, the controller 200 may compare the magnitudes of the five image data values and determine the output order of the image data in ascending order, starting from the data with the lowest grayscale value. For example, the controller 200 may compare image-data magnitudes by examining bits in order from the most significant bit down to the least significant bit.

FIG. 6 illustrates a case where Data1 has a grayscale value of 250, Data2 has a grayscale value of 100, Data3 has a grayscale value of 130, Data4 has a grayscale value of 180, and Data5 has a grayscale value of 70.

The controller 200 may determine the output order of the image data as Data5, Data2, Data3, Data4, Data1 based on the magnitudes of the first to fifth image data Data1, Data2, Data3, Data4, and Data5. The controller 200 may determine the switching order of the demultiplexer to match the output order of the image data.

The controller 200 may output the image data to the data driver 400 based on the output order of the image data and provide switch control signals to the switches in the order of fifth switch SW5, second switch SW2, third switch SW3, fourth switch SW4, and first switch SW1 based on the switching order of the demultiplexer.

The controller 200 may turn on the switches of the demultiplexer in ascending order of grayscale, starting from the lowest grayscale, to ensure that the data voltage is delivered to the subpixels accordingly.

As illustrated in FIG. 6, the fifth switch SW5 turns on at the first switching time S/W Time1, the second switch SW2 turns on at the second switching time S/W Time2, the third switch SW3 turns on at the third switching time S/W Time3, the fourth switch SW4 turns on at the fourth switching time S/W Time4, and the first switch SW1 turns on at the fifth switching time S/W Time5.

By determining the switching order of the demultiplexer based on the grayscale values of the first to fifth image data Data1, Data2, Data3, Data4, and Data5 and outputting the image data in ascending order starting from the lowest grayscale, the display apparatus resolves charging rate issues associated with demultiplexer technology.

That is, the display apparatus can improve image quality by solving the high-grayscale charging rate issue by controlling the first to fifth switches SW1, SW2, SW3, SW4, and SW5 of the demultiplexer to charge the subpixels in ascending order of the lower grayscale image data.

The controller 200 includes a comparator 210, a first sequence circuit 220, a demultiplexer controller 230, and a second sequence circuit 240.

The comparator 210 compares the first to fifth image data Data1, Data2, Data3, Data4, and Data5 of the horizontal period 1H of the image data. For example, the comparator 210 may compare the bits of the first to fifth image data Data1, Data2, Data3, Data4, and Data5. Assuming the image data is 10 bits, the comparator 210 may compare at least the two most significant bits.

The first sequence circuit 220 may arrange the first to fifth image data Data1, Data2, Data3, Data4, and Data5 of a horizontal period (1H) in ascending order based on the comparison result of the comparator 210.

The demultiplexer controller 230 may determine the switching order of the demultiplexer to match the output order of the image data based on the comparison result of the comparator 210. The second sequence circuit 240 may arrange the switch control signals for driving the switches of the demultiplexer in accordance with the output order of the image data based on the switching order of the demultiplexer.

The data driver 400 may receive the image data in the output order adjusted by the controller 200, convert the image data into data voltages through the digital-to-analog converter 420, and output the data voltages to the display panel 100 through the output buffer 430.

The display panel 100 may include first to fifth switches SW1, SW2, SW3, SW4, and SW5 of the demultiplexer. The first to fifth switches SW1, SW2, SW3, SW4, and SW5 of the demultiplexer may receive switch control signals corresponding to the image data output order adjusted by the controller 200, and may deliver data voltages to corresponding first to fifth subpixels in response to the switch control signals. The first to fifth subpixels may be charged by the data voltages in ascending order from a lower grayscale level.

Accordingly, the display apparatus of the present disclosure may resolve the issue of insufficient charging rate of the demultiplexer by charging subpixels in ascending order from image data having lower grayscale levels.

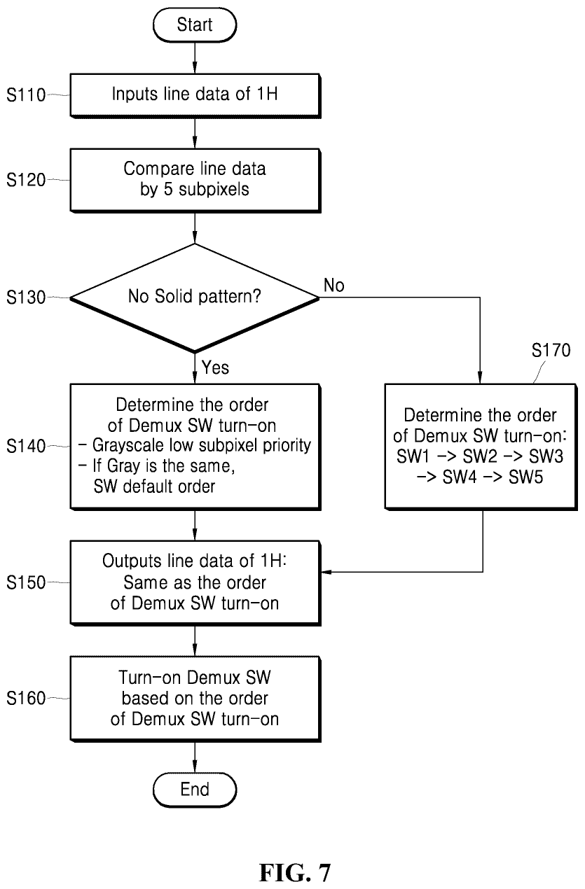

FIG. 7 is a flowchart illustrating the control flow of a display apparatus according to an example embodiment of this specification.

As illustrated in FIG. 7, the controller 200 receives line data for one horizontal period 1H in operation S110. Here, the line data represents first to fifth image data to be applied to first to fifth subpixels during the horizontal period 1H. Although this specification exemplifies a case where the controller 200 serves as the main unit to determine the output order of the image data based on the values of the image data and determine the switching order of the demultiplexer based on the output order of the image data, it is not limited thereto. Alternatively, the data driver 400 may serve as the main unit to perform these functions. In another embodiment, a separate control device may serve as the main unit to perform the same functions.

In operation S120, the controller 200 compares the magnitudes of the first to fifth image data corresponding to the five subpixels.

In operation S130, the controller 200 determines whether the input image is a solid pattern by comparing the magnitudes of the first to fifth image data. For example, the controller 200 may determine that the input image is a solid pattern when the values of the first to fifth image data are all the same, and may determine that the input image is not a solid pattern when the values of the first to fifth image data differ.

When it is determined that the first to fifth image data do not constitute a solid pattern, the controller 200 determines, in operation S140, the output order of the image data in ascending order from the image data having the lower grayscale levels among the first to fifth image data, and determines the switching order of the demultiplexer to match the output order of the image data.

When it is determined that some of the first to fifth image data have the same grayscale level, the output order of the image data and the switching order of the demultiplexer may be adjusted according to a default order. For example, the default order may be set as first image data, second image data, third image data, fourth image data, and fifth image data. For example, when the third and fourth image data have the same grayscale level, the output order may be determined such that the third image data is output before the fourth image data.

In operation S150, the controller 200 arranges the first to fifth image data in the determined output order and outputs the arranged first to fifth image data to the data driver 400. In operation S160, the controller 200 also outputs switch control signals to the first to fifth switches SW1, SW2, SW3, SW4, and SW5 of the demultiplexer in accordance with the switching order of the demultiplexer.

When it is determined that the first to fifth image data constitute a solid pattern, the controller 200 may determine, in operation S170, the output order of the image data and the switching order of the demultiplexer according to the default order. For example, the default order may be set as first image data, second image data, third image data, fourth image data, and fifth image data.

When the image data is a solid pattern, the controller 200 may determine the output order of the image data and the switching order of the demultiplexer so that the first to fifth image data are output in the order of first, second, third, fourth, and fifth image data.

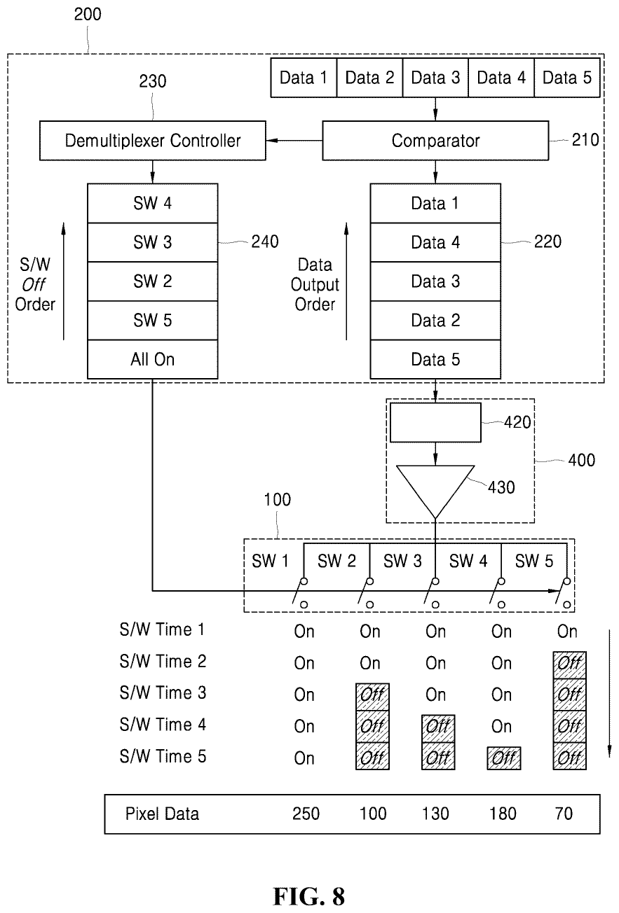

FIG. 8 is a diagram illustrating the control flow of a display apparatus according to another example embodiment of this specification.

As illustrated in FIG. 8, the display apparatus may determine the output order of the image data in ascending order from the image data having lower grayscale levels among the first to fifth image data Data1, Data2, Data3, Data4, and Data5, and may determine the switching order of the demultiplexer according to the output order of the image data.

The controller 200 may compare the magnitudes of the input first to fifth image data Data1, Data2, Data3, Data4, and Data5 and determine the output order of the first to fifth image data Data1, Data2, Data3, Data4, and Data5 in ascending order from the image data having lower grayscale levels.

FIG. 8 illustrates a case in which the first image data Data1 has a grayscale level of 250, the second image data Data2 has a grayscale level of 100, the third image data Data3 has a grayscale level of 130, the fourth image data Data4 has a grayscale level of 180, and the fifth image data Data5 has a grayscale level of 70.

The controller 200 may determine the output order of the image data as Data5, Data2, Data3, Data4, Data1 based on the magnitudes of the first through fifth image data Data1, Data2, Data3, Data4, and Data5.

The controller 200 may turn on all of the first to fifth switches of the demultiplexer and determine the switching order of the demultiplexer such that the fifth switch, second switch, third switch, and fourth switch are sequentially turned off according to the output order of the image data.

Based on the output order of the image data, the controller 200 may output the fifth image data, second image data, third image data, fourth image data, and first image data to the data driver 400, and based on the switching order of the demultiplexer, the controller 200 may turn on all of the first to fifth switches and then sequentially turn off the fifth switch SW5, second switch SW2, third switch SW3, and fourth switch SW4.

By turning off the switches of the demultiplexer based on the switching order of the demultiplexer, the controller 200 ensures subpixels are charged in ascending order starting from the lowest grayscale, resolving the issue of reduced brightness due to insufficient charging time.

At the first switching time S/W Time1, all first to fifth switches turn on, at the second switching time S/W Time2, the fifth switch SW5 turns off, at the third switching time S/W Time3, the second switch SW2 turns off, at the fourth switching time S/W Time4, the third switch SW3 turns off, and at the fifth switching time S/W Time5, the fourth switch SW4 turns off.

By turning off the first to fifth switches SW1, SW2, SW3, SW4, and SW5 of demultiplexer in this manner, the display apparatus ensures subpixels are charged in ascending order starting from the lowest grayscale, addressing high-grayscale charging rate issues caused by insufficient charging time.

The controller 200 includes a comparator 210, a first sequence circuit 220, a demultiplexer controller 230, and a second sequence circuit 240. Descriptions of identical parts are replaced with the above explanation.

The second sequence circuit 240 first arranges switch control signals to turn on all demultiplexer switches SW1, SW2, SW3, SW4, and SW5, then arranges switch control signals to turn off the switches in the order SW5, SW2, SW3, and SW4 according to the data output order. The first to fifth subpixels complete data charging in ascending order starting from the lowest grayscale.

Thus, the display apparatus of this disclosure turns on all first to fifth switches of the demultiplexer while outputting the fifth image data with the lowest grayscale among the first to fifth image data, charging the first to fifth subpixels, and turns off the switches in ascending order starting from the lowest grayscale image data. By completing charging in ascending order starting from subpixels displaying low-grayscale image data, the display apparatus can charge subpixels to the desired grayscale regardless of the image data pattern.

Additionally, the display apparatus determines the demultiplexer's switching order based on the grayscale values of the image data and switches the demultiplexer's switches accordingly, reducing color shifts and line mura caused by charging rate differences.

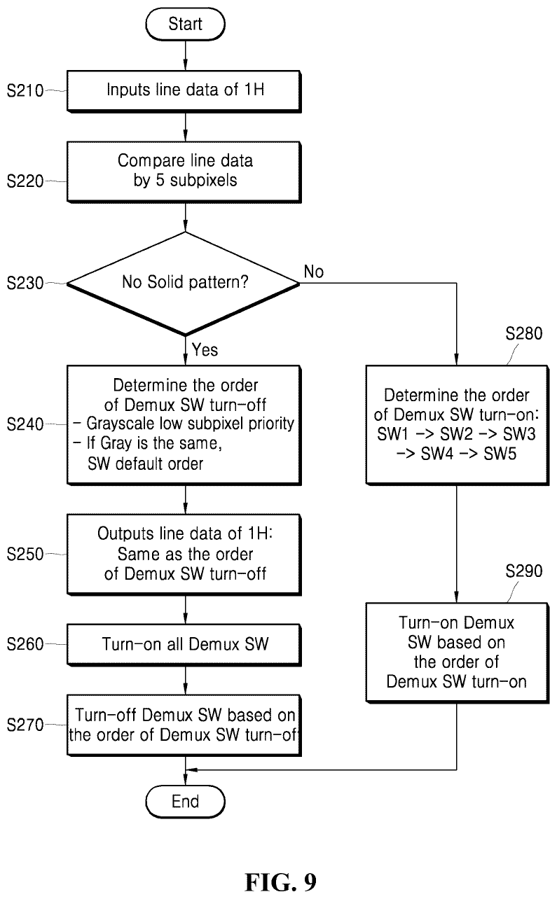

FIG. 9 is a flowchart illustrating the control flow of a display apparatus according to another embodiment of this specification.

As illustrated in FIG. 9, the controller 200 receives image data of the horizontal period 1H in operation S210.

In operation S220, the controller 200 compares the magnitudes of the first to fifth image data for each set of the five subpixels from the received image data.

The controller 200 determines whether the image follows a solid pattern. In operation S230, the controller 200 may determine that the input image is a solid pattern when the values of the first to fifth image data are all the same, and may determine that the input image is not a solid pattern when the values of the first to fifth image data differ.

When the image is not a solid pattern, the controller 200 determines, in operation S240, the output order of the image data in ascending order, starting from the image data with the lowest grayscale. Sequentially in operation S240, the controller 200 determines the switching order of the demultiplexer to turn off the switches according to the output order of the image data.

In operation S250, the controller 200 arranges the first through fifth image data in the determined output order and outputs the arranged first through fifth image data to the data driver 400.

In operation S260, the controller 200 turns on all switches SW1, SW2, SW3, SW4, and SW5 of the demultiplexer. In operation S270, the controller 200 turns off switches SW1, SW2, SW3, SW4, and SW5 of the demultiplexer according to the switching order.

When the pattern is solid, the controller 200 determines, in operation S280, the output order of the image data and the switching order of the demultiplexer in the default order. For example, the default order may be set as first image data, second image data, third image data, fourth image data, and fifth image data. In operation S290, the controller 200 outputs switch control signals to the first to fifth switches SW1, SW2, SW3, SW4, and SW5 of the demultiplexer in accordance with the switching order of the demultiplexer.

In this way, the controller 200 turns on all switches SW1, SW2, SW3, SW4, and SW5 of the demultiplexer and, based on the switching order of the demultiplexer, completes the charging of the subpixels from the lowest to the highest grayscale in ascending order, thereby solving the image quality problems caused by insufficient charging time.

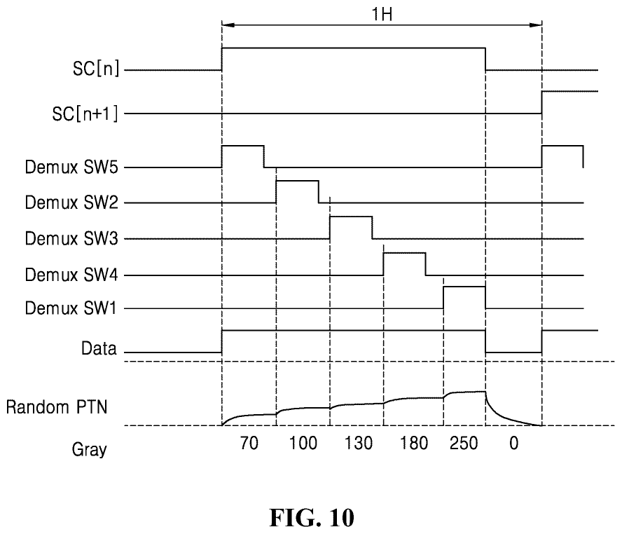

FIG. 10 illustrates an operation timing diagram of a display apparatus according to an example embodiment of this specification.

FIG. 10 illustrates a case of a random pattern (Random PTN), in which the first image data has a grayscale of 250, the second image data has a grayscale of 100, the third image data has a grayscale of 130, the fourth image data has a grayscale of 180, and the fifth image data has a grayscale of 70.

The display apparatus determines the output order of the first to fifth image data as the fifth, second, third, fourth, and first image data based on their grayscale values, and determines the switching order of the demultiplexer accordingly.

The first to fifth switches of the demultiplexer may be turned on in the order of the fifth switch, second switch, third switch, fourth switch, and first switch.

That is, since the subpixels are charged starting from the image data with a lower grayscale, even when the first image data with a high grayscale value of 250 is input, luminance degradation due to insufficient charging time can be prevented or suppressed.

In addition, by controlling the switches of the demultiplexer so that the subpixels are charged in ascending order from the image data with a lower grayscale, the charging rate difference can be reduced even when the grayscale difference between subpixels is large, thereby preventing or suppressing color shifts and line mura and improving image quality.

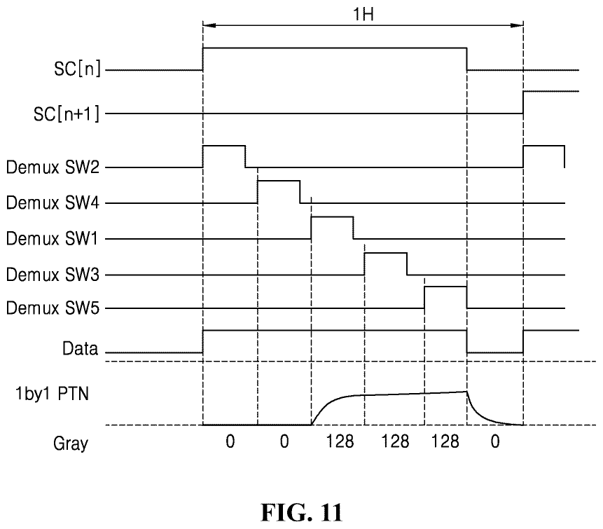

FIG. 11 illustrates another operation timing diagram of a display apparatus according to an example embodiment of this specification.

FIG. 11 illustrates a case of a random pattern Random PTN, in which the first image data has a grayscale of 128, the second image data has a grayscale of 0, the third image data has a grayscale of 128, the fourth image data has a grayscale of 0, and the fifth image data has a grayscale of 128.

The display apparatus determines the output order of the first to fifth image data based on their grayscale levels such that the image data are output in the order of the second, fourth, first, third, and fifth image data, and determines the switching order of the demultiplexer switches to correspond to the output order.

The first to fifth switches of the demultiplexer may be turned on in the order of the second switch, the fourth switch, the first switch, the third switch, and the fifth switch. That is, even in a case where high grayscale 128 and low grayscale 0 are alternately applied as the image data, the subpixels are charged in the order of lower grayscale levels first, thereby preventing or suppressing luminance degradation caused by insufficient charging time.

As such, by controlling the switches of the demultiplexer so that the subpixels are charged in ascending order from the image data with a lower grayscale, the charging rate difference can be reduced even when the grayscale difference between subpixels is large, thereby preventing or suppressing color shifts and line mura and improving image quality.

A display apparatus according to an example embodiment of this specification includes a data driver configured to output a data voltage corresponding to image data; a display panel including a demultiplexer configured to selectively deliver the data voltage to a plurality of subpixels, and a controller configured to determine an output order of the image data to prioritize low-grayscale image data for output to the data driver, and to determine a switching order of the demultiplexer in accordance with the output order of the image data.

According to an example embodiment, the controller may compare magnitudes of image data within a horizontal period and determine the output order of the image data in an ascending order starting from the lowest grayscale data among the image data within the horizontal period.

According to an example embodiment, based on the demultiplexer having k switches (k is a natural number of 2 or greater), the controller may compare magnitudes of the image data in groups of k and determine the output order of the image data in an ascending order starting from the lowest grayscale data.

According to an example embodiment, the controller may output the image data to the data driver based on the output order of the image data, and turn on or turn off the switches of the demultiplexer based on the switching order of the demultiplexer.

According to an example embodiment, the controller may turn on the switches of the demultiplexer based on the switching order of the demultiplexer to deliver the data voltage to the subpixels in an ascending order of grayscale.

According to an example embodiment, the controller may turn on all switches of the demultiplexer and turn off the switches of the demultiplexer based on the switching order of the demultiplexer to complete charging of the subpixels in an ascending order of grayscale.

According to an example embodiment, the controller may include a comparator configured to compare k pieces of image data (k is a natural number of 2 or greater) within a horizontal period, a first sequence circuit configured to arrange the image data of the horizontal period in an ascending order based on the comparison result of the comparator, a demultiplexer controller configured to determine the switching order of the demultiplexer based on the comparison result of the comparator, and a second sequence circuit configured arrange switch control signals to drive the switches of the demultiplexer in accordance with the output order of the image data based on the switching order of the demultiplexer.

A display apparatus according to an example embodiment of this specification includes a demultiplexer including first to fifth switches and configured to selectively deliver a data voltage input from a single data pin to first to fifth subpixels through the first to fifth switches, respectively, and a controller configured to receive first to fifth image data within a first horizontal period, compare magnitudes of the first to fifth image data, determine an output order of the first to fifth image data to be output in an ascending order starting from the lowest grayscale image data, among the first to fifth image data, and control the first to fifth switches based on the output order of the first to fifth image data.

According to an example embodiment, the controller may arrange switch control signals to turn on the first to fifth switches in the ascending order starting from the switch configured to deliver the lowest grayscale data voltage.

According to an example embodiment, the controller may output the first to fifth image data to a data driver in the ascending order starting from the lowest grayscale image data, and output the switch control signals to the demultiplexer to turn on the first to fifth switches in the ascending order starting from the switch configured to deliver the lowest grayscale data voltage.

According to an example embodiment, the controller may arrange switch control signals to turn on all of the first to fifth switches, and then arrange the switch control signals to turn off the first to fifth switches in the ascending order starting from the switch configured to deliver the lowest grayscale data voltage.

A method for controlling the driving of a display apparatus according to an example embodiment of this specification includes receiving first to fifth image data within a first horizontal period, comparing magnitudes of the first to fifth image data, determining an output order of the first to fifth image data in an ascending order starting from the lowest grayscale image data, among the first to fifth image data, arranging the first to fifth image data to be output in ascending order starting from the lowest grayscale image data based on the output order, determining a switching order of a demultiplexer based on the output order of the first to fifth image data, and arranging switch control signals to drive first to fifth switches of the demultiplexer based on the switching order of the demultiplexer.

According to an example embodiment, the arranging of the switch control signals may include arranging the switch control signals to turn on the first to fifth switches of the demultiplexer in the ascending order starting from the switch delivering the lowest grayscale data voltage.

According to an example embodiment, the method may further include outputting the first to fifth image data in ascending order starting from the lowest grayscale image data, and turning on the first to fifth switches of the demultiplexer in the ascending order starting from the switch delivering the lowest grayscale data voltage.

According to an example embodiment, the arranging of the switch control signals may include arranging the switch control signals to turn on all of the first to fifth switches of the demultiplexer, and arranging the switch control signals to turn off the first to fifth switches in the ascending order starting from the switch configured to deliver the lowest grayscale data voltage.

According to an example embodiment, the method may further include outputting the first to fifth image data in the ascending order starting from the lowest grayscale image data, turning on all of the first to fifth switches of the demultiplexer, and turning off the first to fifth switches of the demultiplexer in the ascending order starting from the switch configured to deliver the lowest grayscale data voltage.

Although example embodiments of the present disclosure have been described in detail with reference to the accompanying drawings, it should be noted that the present disclosure is not necessarily limited to these example embodiments and can be modified in various ways without departing from the scope of the technical concept of the present disclosure. Therefore, the embodiments disclosed in this specification are not intended to limit but to describe the technical idea of the present disclosure by way of example, and the scope of the technical idea of the disclosure is not limited by the embodiments. Therefore, it should be understood that the embodiments described above are examples and do not limit the present disclosure in all aspects.

What is claimed is:

1. A display apparatus, comprising:
a data driver configured to output a data voltage corresponding to image data;
a display panel including a demultiplexer configured to selectively deliver the data voltage to a plurality of subpixels; and
a controller configured to determine an output order of the image data to prioritize low-grayscale image data for output to the data driver, and to determine a switching order of the demultiplexer in accordance with the output order of the image data.

2. The display apparatus of claim 1, wherein the controller is further configured to compare magnitudes of image data within a horizontal period and to determine the output order of the image data in an ascending order starting from the lowest grayscale data among the image data within the horizontal period.

3. The display apparatus of claim 1, wherein, based on the demultiplexer having k switches, k being a natural number greater than or equal to 2, the controller is further configured to compare magnitudes of the image data in groups of k and to determine the output order of the image data in an ascending order starting from the lowest grayscale data.

4. The display apparatus of claim 1, wherein the controller is further configured to output the image data to the data driver based on the output order of the image data, and to turn on or turn off switches of the demultiplexer based on the switching order of the demultiplexer.

5. The display apparatus of claim 4, wherein the controller is further configured to turn on the switches of the demultiplexer based on the switching order of the demultiplexer to deliver the data voltage to the subpixels in ascending order of grayscale.

6. The display apparatus of claim 4, wherein the controller is further configured to turn on all switches of the demultiplexer and to turn off the switches of the demultiplexer based on the switching order of the demultiplexer to complete charging of the subpixels in ascending order of grayscale.

7. The display apparatus of claim 1, wherein the controller comprises:
a comparator configured to compare k pieces of image data within a horizontal period, k being a natural number greater than or equal to 2;
a first sequence circuit configured to arrange the image data of the horizontal period in an ascending order based on a comparison result of the comparator;
a demultiplexer controller configured to determine the switching order of the demultiplexer based on the comparison result of the comparator; and
a second sequence circuit configured to arrange switch control signals to drive switches of the demultiplexer in accordance with the output order of the image data based on the switching order of the demultiplexer.

8. A display apparatus, comprising:
a demultiplexer including first to fifth switches and configured to selectively deliver a data voltage input from a single data pin to first to fifth subpixels through the first to fifth switches, respectively; and
a controller configured to receive first to fifth image data within a first horizontal period, compare magnitudes of the first to fifth image data, determine an output order of the first to fifth image data to be output in an ascending order starting from the lowest grayscale image data, among the first to fifth image data, and control the first to fifth switches based on the output order of the first to fifth image data.

9. The display apparatus of claim 8, wherein the controller is further configured to arrange switch control signals to turn on the first to fifth switches in the ascending order starting from the switch configured to deliver the lowest grayscale data voltage.

10. The display apparatus of claim 9, wherein the controller is further configured to output the first to fifth image data to a data driver in the ascending order starting from the lowest grayscale image data, and to output the switch control signals to the demultiplexer to turn on the first to fifth switches in the ascending order starting from the switch configured to deliver the lowest grayscale data voltage.

11. The display apparatus of claim 8, wherein the controller is further configured to arrange switch control signals to turn on all of the first to fifth switches, and then to arrange the switch control signals to turn off the first to fifth switches in the ascending order starting from the switch configured to deliver the lowest grayscale data voltage.

12. A method for driving a display apparatus, the method comprising:
receiving first to fifth image data within a first horizontal period;
comparing magnitudes of the first to fifth image data;
determining an output order of the first to fifth image data in an ascending order starting from the lowest grayscale image data among the first to fifth image data;
arranging the first to fifth image data to be output in the ascending order starting from the lowest grayscale image data based on the output order;
determining a switching order of a demultiplexer based on the output order of the first to fifth image data; and
arranging switch control signals to drive first to fifth switches of the demultiplexer based on the switching order of the demultiplexer.

13. The method of claim 12, wherein the arranging of the switch control signals comprises arranging the switch control signals to turn on the first to fifth switches of the demultiplexer in the ascending order starting from the switch delivering the lowest grayscale data voltage.

14. The method of claim 13, further comprising:
outputting the first to fifth image data in the ascending order starting from the lowest grayscale image data; and
turning on the first to fifth switches of the demultiplexer in the ascending order starting from the switch delivering the lowest grayscale data voltage.

15. The method of claim 12, wherein the arranging of the switch control signals comprises:
arranging the switch control signals to turn on all of the first to fifth switches of the demultiplexer; and
arranging the switch control signals to turn off the first to fifth switches in the ascending order starting from the switch configured to deliver the lowest grayscale data voltage.

16. The method of claim 15, further comprising:
outputting the first to fifth image data in the ascending order starting from the lowest grayscale image data;
turning on all of the first to fifth switches of the demultiplexer; and
turning off the first to fifth switches of the demultiplexer in the ascending order starting from the switch configured to deliver the lowest grayscale data voltage.
